(19) United States
(12) Patent Application Publication
(10) Pub. No.: US 2018/0245943 A1
(43) Pub. Date: Aug. 30, 2018

(54) NAVIGATION UX ENHANCEMENT - AUTOMATIC ROUTING TO NEAREST PARKING LOT OR GARAGE

(71) Applicant: Panasonic Automatic Systems Company of America, Division of Panasonic Corporation of North America, Peachtree City, GA (US)

(72) Inventors: ANANTHA KRISHNA CHANDRA, FARMINGTON HILLS, MI (US); ANNAMALAI PARAMASIVAM, NOVI, MI (US)

(73) Assignee: Panasonic Automatic Systems Company of America, Division of Panasonic Corporation of North America

(21) Appl. No.: 15/895,688

(22) Filed: Feb. 13, 2018

Related U.S. Application Data
(60) Provisional application No. 62/458,718, filed on Feb. 14, 2017.

(51) Int. Cl. G01C 21/36; G01C 21/26

(52) U.S. Cl. CPC G01C 21/3685; G01C 21/265; G01C 21/3629

(57) ABSTRACT

A method of providing navigation information in a motor vehicle includes the following computer-implemented steps. Received from a user is an identity of a destination that the user would like to go to. It is determined that the destination is not a parking area. Ascertained is a location of a parking area within a threshold distance of the destination. The user is asked if he would like to go to the parking area instead of the destination. Received from the user is an indication that he would like to go to the parking area instead of the destination. In response to receiving the indication from the user, navigation guidance information is provided to arrive at the parking area.

### CROSS-REFERENCED TO RELATED APPLICATIONS

This application claims benefit of U.S. Provisional Application No. 62/458,718 filed on Feb. 14, 2017, which the disclosure of which is hereby incorporated by reference in its entirety for all purposes.

### FIELD OF THE INVENTION

The disclosure relates to a navigation system for a vehicle, and, more particularly, to using a vehicle navigation system to find a parking space for the vehicle.

### BACKGROUND OF THE INVENTION

Currently, all navigation systems direct the user to a user specified “exact” address. All current implementations have two different work flows. A first work flow is for the user entering a specific address, and then a second work flow is for finding a parking lot. The work load is heavier for users who do not plan the parking ahead of time. They reach the destination in the high-density area and then try to search for the nearest parking location. This results in a stressful user experience in crowded areas where the user has to operate the navigation system on the road and often leads to a delayed time of arrival for the user.

Known navigation systems provide navigation capabilities, which help drivers take the best route available to their destinations. The user can enter the destination address for the route using a graphical user interface, voice interactions, or smartphone inputs. When the destination is set by any of these methods, the system calculates the optimal route, depending on the user settings, to the “exact” specified address. The user is enabled to browse and select certain “points of interests,” such as a parking lot or parking garage, along the route or near the destination or the current location.

If the destination is in a high-density area where parking is not easily available, then, upon reaching the destination, the driver must find a nearby parking spot for the car by selecting a parking lot/garage in the navigation system. A problem, however, is that if the destination address is in a high-density area where parking is not easily available, then the driver has to go through multiple workflows in the navigation system to reach his destination. A first such workflow is illustrated in FIG. 1 wherein the navigation system takes the user to his destination, and a second such workflow is illustrated in FIG. 2 wherein the navigation system takes the user to parking near his destination.

The known navigation systems include several major drawbacks. A first such drawback is that the setting of the destination route and the finding of parking near the destination in all the existing systems is a two-step process that is implemented as two different work flows.

A second drawback is that, unless the user has planned ahead of time, he must search for nearby parking locations after he reaches the destination. This results in a delayed time of arrival.

A third drawback is that, when the user is driving, most known navigation systems prevent the user from interacting with system by employing driver anti-distraction methods. This prevents the drivers from effectively finding a parking spot when they are close to their destination.

A fourth drawback is that active engagement with known navigation systems hinders the ability of the user to concentrate on the road ahead and may result in incidents. For example, parking a car near Cloud-gate, Millennium Park, Navy Pier, Sears tower, or Devon Street in Chicago can be quite challenging. Similarly, if the user tries to find parking near Penn Station or Times Square in New York while the vehicle is in motion, given the traffic conditions and density, incidents on the road can result.

### SUMMARY

The present invention may provide a user with an improved user experience by minimizing the number of engagements or interactions required with a navigation system in order to find a parking location in high density areas. The present invention may take into consideration whether parking is feasible in such locations, and, if not, enables the user to drive to a proper, or more feasible parking location that is close to the user's end destination.

In one embodiment, the invention comprises a method of providing navigation information in a motor vehicle, including the following computer-implemented steps. Received from a user is an identity of a destination that the user would like to go to. It is determined that the destination is not a parking area. Ascertained is a location of a parking area within a threshold distance of the destination. The user is asked if he would like to go to the parking area instead of the destination. Received from the user is an indication that he would like to go to the parking area instead of the destination. In response to receiving the indication from the user, navigation guidance information is provided to arrive at the parking area.

In another embodiment, the invention comprises a motor vehicle including a user interface having a loudspeaker, a display screen, a keypad, and/or a microphone. The user interface receives from a user an identity of a destination that the user would like to go to, and asks the user if he would like to go to a parking area instead of the destination. The user interface receives from the user an indication that he would like to go to the parking area instead of the destination. A navigation system is communicatively coupled to the user interface. The navigation system determines that the destination is not a parking area, and ascertains a location of a parking area within a threshold distance of the destination. In response to the user interface receiving the indication from the user, the navigation system provides navigation guidance information to arrive at the parking area.

In yet another embodiment, the invention comprises a method of providing navigation information in a motor vehicle, including the following computer-implemented steps. Received from a user is an identity of a destination that the user would like to go to. It is determined that the destination is not a parking area. A location of a parking area within a threshold distance of the destination is ascertained. The user is asked if he would like to go to the parking area instead of the destination. Received from the user is an indication that he would like to go to the parking area instead of the destination. It is determined that there is an open parking space in the parking area. In response to receiving the indication from the user, and in response to determining that there is an open parking space in the parking area, navigation guidance information to arrive at the parking area is provided.

An advantage of the present invention is that it results in less engagement of the driver with the navigation system, less driver distraction, and hence fewer incidents on the road.

Another advantage of the invention is that it avoids the driver being late to appointments due to not being able to find parking.

### BRIEF DESCRIPTION OF THE DRAWINGS

A better understanding of the present invention will be had upon reference to the following description in conjunction with the accompanying drawings.

FIG. 1 is a flow chart of an example workflow of the prior art wherein the navigation system takes the user to his destination.

FIG. 2 is a flow chart of an example workflow of the prior art wherein the navigation system takes the user to parking near his destination.

FIG. 3 is a flow chart of one embodiment of a navigation method of the present invention.

FIG. 4A is a first portion of a flow chart of another embodiment of a navigation method of the present invention.

FIG. 4B is a second portion of the flow chart of FIG. 4A.

FIG. 5 is a block diagram of one embodiment of a navigation arrangement of the present invention.

FIG. 6 is a flow chart of one embodiment of a method of the present invention for providing navigation information in a motor vehicle.

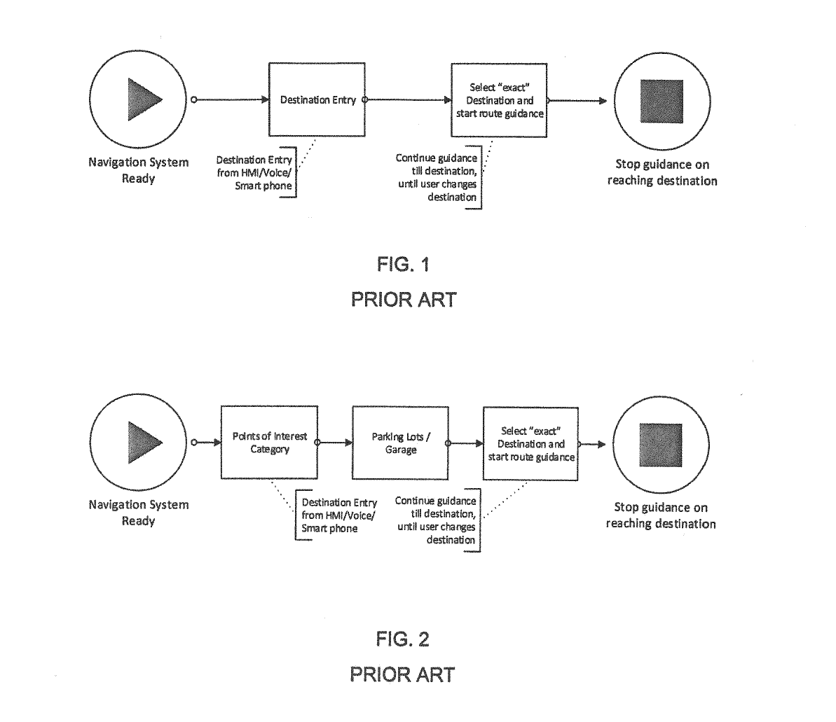

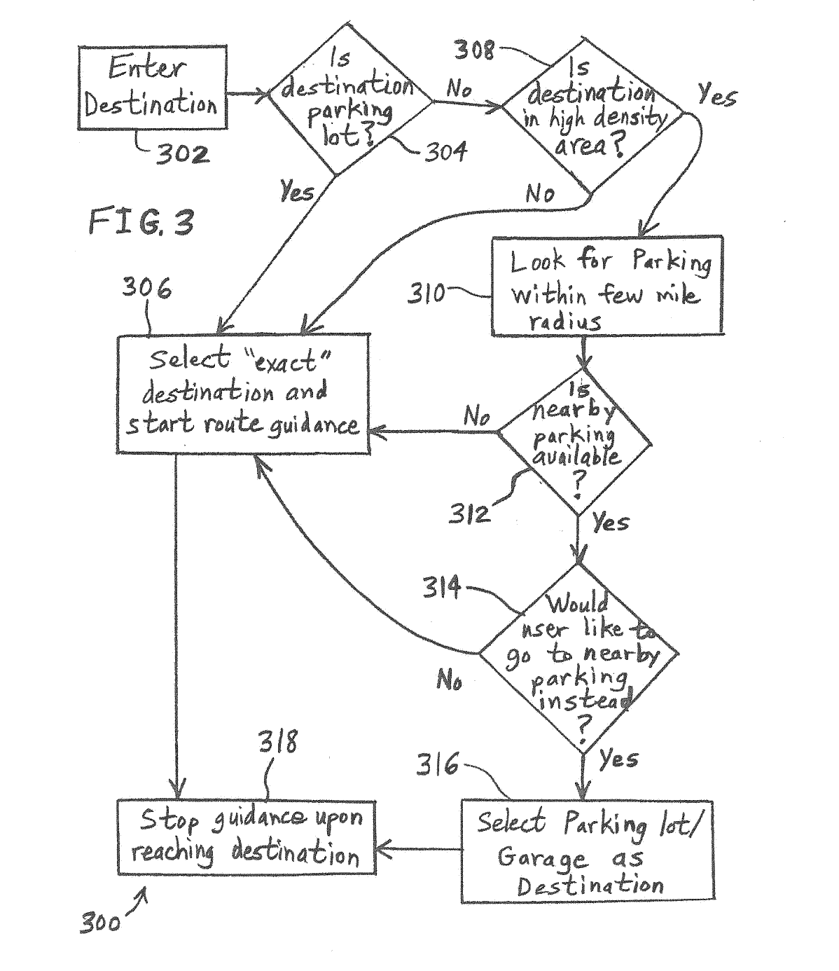

### DETAILED DESCRIPTION OF THE PREFERRED EMBODIMENTS

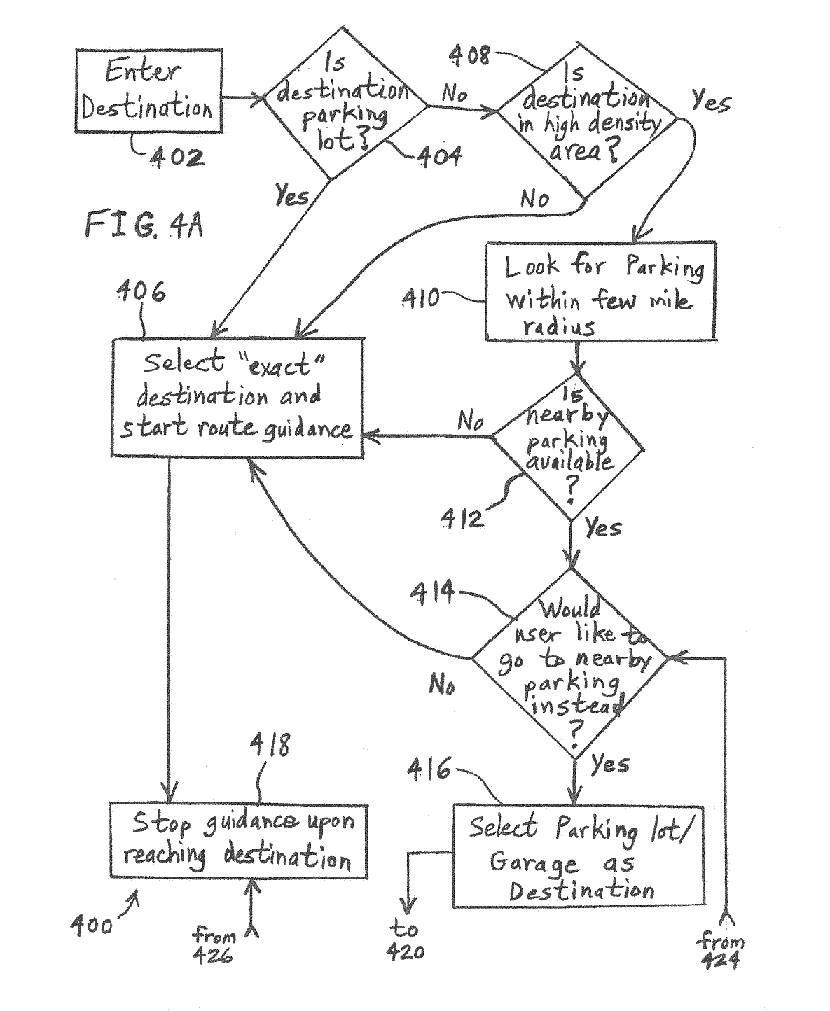

FIG. 3 illustrates one embodiment of a navigation method 300 of the present invention. In a first step 302, a destination is entered into the navigation system by a user. The entry of the destination may be via a human machine interface (HMI), voice, or a smartphone, for example.

In a next step 304, it is determined whether the destination entered by the user in step 302 is a parking lot. If so, then operation proceeds to step 306 wherein route guidance is begun to the “exact” destination entered in step 302. However, if it is determined in step 304 that the destination entered by the user is step 302 is not a parking lot, then operation proceeds to step 308 wherein it is determined whether the destination entered by the user in step 302 is a high-density area.

If it is determined in step 308 that the destination entered by the user in step 302 is not a high-density area, then operation proceeds to step 306 wherein route guidance is begun to the “exact” destination entered in step 302. However, if it is determined in step 308 that the destination entered by the user in step 302 is indeed a high-density area, then operation proceeds to step 310 wherein a parking facility within a few mile radius of the current location of the vehicle is looked for. A database outside of the vehicle, and/or a database inside the vehicle may be consulted and used to search for the parking facility.

Next, in step 312, it is determined whether nearby parking is available, e.g., within a three-mile radius. If it is determined in step 312 that nearby parking is not available, then operation proceeds to step 306 wherein route guidance is begun to the “exact” destination entered in step 302. However, if it is determined in step 312 that nearby parking is available, then operation proceeds to step 314 wherein it is determined whether the user would like to go to nearby parking instead of the destination that he entered in step 302. For example, the user may be audibly or textually prompted “Would you like me to take you to a nearby parking lot instead?”

If the user answers in step 314 that he would not like to go to nearby parking instead of the destination he entered in step 302, then operation proceeds to step 306 wherein route guidance is begun to the “exact” destination entered in step 302. However, if the user answers in step 314 that he would like to go to nearby parking instead of the destination he entered in step 302, then operation proceeds to step 316 wherein a nearby parking lot or garage is selected as the destination. In a final step 318, navigation guidance is stopped upon the vehicle reaching the destination, regardless of whether the destination is the “exact” destination from step 306 or the parking lot/garage selected in step 316.

As described above with reference to FIG. 3, when the user selects a destination address that is not a parking lot, the navigation system may find out whether the destination is in a high-density area. If the destination is in a high-density area, then the navigation system may ask the user if they would rather go directly to a nearby parking lot instead of routing to the destination address. Depending on the user's selection, the navigation system may route either to the address or directly to the parking lot/garage. This reduces the number of interactions that the user has to perform to find a parking location for the car.

The human machine interface (HMI) may present information to the user about the nearby parking lots, enabling the user to make an informed selection. The information may include the parking lot's distance from the original destination, the number of slots or parking spaces available, and/or the cost of parking at the parking lot.

The prompt in step 314 for automatic routing to a nearby parking lot may not be triggered for destinations such as the user's home or areas where an ample amount of parking is known to be available. In these cases, the user can browse the points of interest to find a parking spot that is nearby.

As used herein, the term “high-density” may refer to areas/cities/destinations where human population and/or number of automobiles per unit area is high. For example, a high-density area may be an area in which it takes a relatively long period of time for a driver within the area to find, drive to, and park in an unoccupied parking space. The term “high-density” may also refer to locations where multiple parking lots are available within some distance to the destination address. High-density areas may be identified using appropriate tagging in the navigation map database.

When routing to the parking lot, and where wireless connectivity is available, the navigation system may keep track of the available number of parking slots or open parking spaces by use of any available methods including, but not limited to, offline data, radio data service (RDS) or Internet. If it is determined that the nearest parking lot/garage is full, then the navigation system may find the next available parking lot/garage.

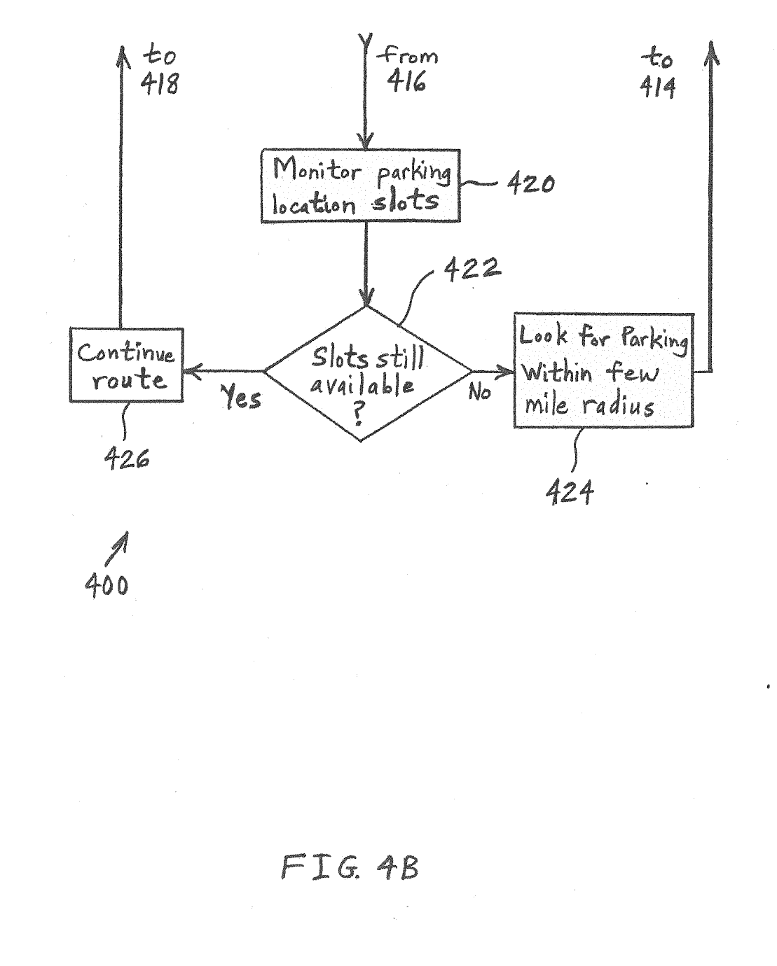

FIGS. 4A-B illustrate another embodiment of a navigation method 400 of the present invention. Steps 402 through 418 are substantially similar to steps 302 through 318 of method 300, and thus are not described in detail herein in order to avoid needless repetition. After a parking lot or garage is selected as a destination in step 416, nearby parking location slots or parking spaces are monitored in step 420. Next, in step 422, it is determined whether nearby open or unoccupied parking slots or spaces are available. If not, then operation proceeds to step 424 wherein a parking space within a few mile radius of the current location of the vehicle is looked for. Operation then returns to step 414.

If, however, it is determined in step 422 that nearby open or unoccupied parking slots or spaces are indeed available, then in step 426 the vehicle continues traveling along the planned route to the destination, which is the parking lot or garage selected in step 416. After step 426, operation proceeds to the final step 418, wherein navigation guidance is stopped upon the vehicle reaching the destination.

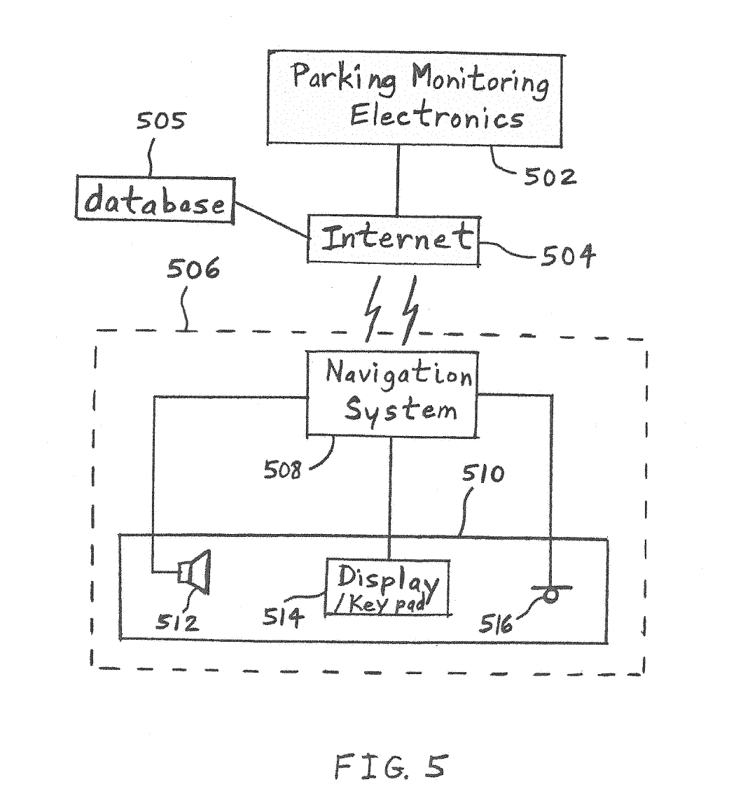

FIG. 5 illustrates one embodiment of an automotive navigation arrangement 500 of the present invention, including parking monitoring electronics 502, the Internet 504, a database 505, and an automobile 506 having a navigation system 508 and a user interface 510. User interface 510 includes a loudspeaker 512, a display screen/keypad 514, a microphone 516, and a camera (not shown). Parking monitoring electronics 502 may be disposed at the location of a parking lot or garage, and may include surveillance cameras, vehicle presence sensors, vehicle ingress/egress counters, computers, etc. Database 505 includes map information and other information to identify the locations, addresses and global coordinates of points of interest, parking facilities, and landmarks.

During use, user interface 510 may prompt the driver whether he would like to go to a nearby parking lot or garage instead of the ultimate destination that he previously entered into navigation system 508. The driver may use user interface 510 to indicate that he would indeed like to go to a nearby parking lot or garage. Parking monitoring electronics 502 may monitor the availability of nearby parking location slots or parking spaces, and may determine whether nearby open or unoccupied parking slots or spaces are available. If so, then parking monitoring electronics 502 may communicate the availability and the exact location (e.g., global coordinates) of the parking space to navigation system 508 through Internet 504. User interface 510 may then inform the driver that a parking space is available, and may provide navigation information to lead to the open parking space. Vehicle 506 may then continue traveling along the planned route to the destination, which is the open parking space. Even after arriving at the parking lot or garage, navigation system 508 may provide navigation information leading to the exact location of an open parking space or slot within the parking lot or garage.

Database 505 may be used plan a route to the entered destination or any other destination, such as a parking facility or an exact parking space, for example. The database, or a supplemental database, may be located within vehicle 506.

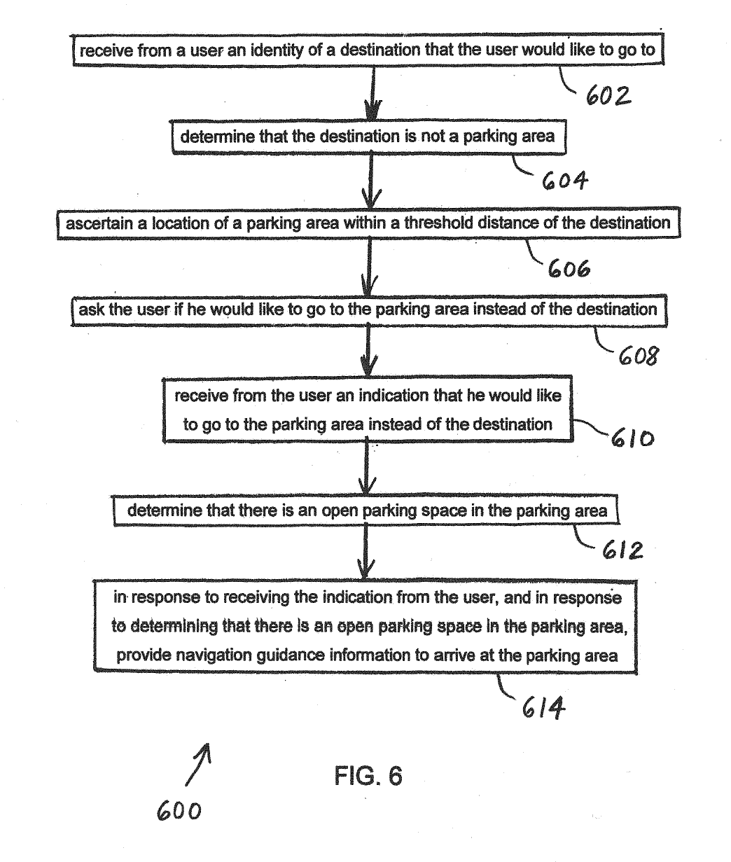

FIG. 6 illustrates one embodiment of a method 600 of the present invention for providing navigation information in a motor vehicle, including the following computer-implemented steps. In a first step 602, an identity of a destination that the user would like to go to is received from a user. For example, a user may enter a text identity, numeric global coordinates identity, or street address identity of a destination into a navigation system via a human machine interface (HMI), user interface, voice, or a smartphone.

Next, in step 604, it is determined that the destination is not a parking area. For example, the destination identity received in step 602 may be compared to a list of similarly formatted parking area identities in database 505. If the destination identity received in step 602 does not match any parking area identity in database 505, then it may be thus determined that the destination is not a parking area.

In a next step 606, a location of a parking area within a threshold distance of the destination is ascertained. For example, a database outside of the vehicle, such as database 505 and/or a database inside the vehicle may be consulted and used to search for the parking area.

In step 608, the user is asked if he would like to go to the parking area instead of the destination. For example, the user may be audibly or textually prompted “Would you like to go to a nearby parking lot instead?”

Next, in step 610, an indication is received from the user that he would like to go to the parking area instead of the destination. For example, the user may answer orally, or by pressing one or more pushbuttons, that he would like to go to nearby parking instead of the destination he entered.

In a next step 612, it is determined that there is an open parking space in the parking area. For example, cameras or other sensors at the parking area, which may be included in parking monitoring electronics 502, may detect whether each individual parking space is occupied or not. This real-time parking space occupancy information may be stored in database 505 via Internet 504.

In a final step 614, in response to receiving the indication from the user, and in response to determining that there is an open parking space in the parking area, navigation guidance information to arrive at the parking area is provided. For example, navigation system 508 may provide navigation guidance information to arrive at the identified nearby parking area.

The present invention may be incorporated in automotive infotainment systems with native navigation, with projection technologies support, such as Google Auto, Apple Carplay, Baidu, or with application navigation support, such as Mobile Navigation. The present invention may also be incorporated in smartphone navigation systems, and in handheld global positioning system (GPS) modules, which may be used in navigating automobiles, bicycles, trucks, and boats, for example.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A method of providing navigation information in a motor vehicle, the method comprising the computer-implemented steps of:
receiving from a user an identity of a destination that the user would like to go to;
determining that the destination is not a parking area;
ascertaining a location of a parking area within a threshold distance of the destination;
asking the user if he would like to go to the parking area instead of the destination;
receiving from the user an indication that he would like to go to the parking area instead of the destination; and
in response to receiving the indication from the user, providing navigation guidance information to arrive at the parking area.

2. The method of claim 1 wherein the destination is determined to not be a parking area by looking up the destination in a database.

3. The method of claim 1 wherein the location of the parking area is ascertained by consulting a database.

4. The method of claim 1 wherein the asking step is performed in response to the ascertaining that a location of a parking area is within a threshold distance of the destination.

5. The method of claim 1 further comprising determining that the destination is in a high-density area.

6. The method of claim 5 wherein the asking step is performed in response to the determining that the destination is in a high-density area.

7. The method of claim 5 wherein the asking step is performed in response to both the ascertaining that a location of a parking area is within a threshold distance of the destination, and the determining that the destination is in a high-density area.

8. A motor vehicle, comprising:
a user interface including at least one of a loudspeaker, a display screen, a keypad, and a microphone, the user interface being configured to:
receive from a user an identity of a destination that the user would like to go to;
ask the user if he would like to go to a parking area instead of the destination; and
receive from the user an indication that he would like to go to the parking area instead of the destination; and
a navigation system communicatively coupled to the user interface and configured to:
determine that the destination is not a parking area;
ascertain a location of a parking area within a threshold distance of the destination; and
in response to the user interface receiving the indication from the user, provide navigation guidance information to arrive at the parking area.

9. The motor vehicle of claim 8 wherein the navigation system is configured to determine that the destination is not a parking area by looking up the destination in a database.

10. The motor vehicle of claim 8 wherein the navigation system is configured to ascertain the location of the parking area by consulting a database.

11. The motor vehicle of claim 8 wherein the user interface is configured to ask the user if he would like to go to a parking area instead of the destination in response to the navigation system ascertaining that a location of a parking area is within a threshold distance of the destination.

12. The motor vehicle of claim 8 wherein the navigation system is configured to determine that the destination is in a high-density area.

13. The motor vehicle of claim 12 wherein the user interface is configured to ask the user if he would like to go to a parking area instead of the destination in response to the navigation system determining that the destination is in a high-density area.

14. The motor vehicle of claim 12 wherein the user interface is configured to ask the user if he would like to go to a parking area instead of the destination in response to both the navigation system ascertaining that a location of a parking area is within a threshold distance of the destination, and the navigation system determining that the destination is in a high-density area.

15. A method of providing navigation information in a motor vehicle, the method comprising the computer-implemented steps of:
receiving from a user an identity of a destination that the user would like to go to;
determining that the destination is not a parking area;
ascertaining a location of a parking area within a threshold distance of the destination;
asking the user if he would like to go to the parking area instead of the destination;
receiving from the user an indication that he would like to go to the parking area instead of the destination;
determining that there is an open parking space in the parking area; and
in response to receiving the indication from the user, and in response to determining that there is an open parking space in the parking area, providing navigation guidance information to arrive at the parking area.

16. The method of claim 15 wherein the destination is determined to not be a parking area by looking up the destination in a database.

17. The method of claim 15 wherein the location of the parking area is ascertained by consulting a database.

18. The method of claim 15 wherein the asking step is performed in response to the ascertaining that a location of a parking area is within a threshold distance of the destination.

19. The method of claim 15 further comprising determining that the destination is in a high-density area, wherein the asking step is performed in response to the determining that the destination is in a high-density area.

20. The method of claim 15 wherein the providing of navigation guidance information to arrive at the parking area includes providing navigation guidance information to arrive at the open parking space.
